(19) United States
(12) Patent Application Publication
(10) Pub. No.: US 2025/0178010 A1
(43) Pub. Date: Jun. 5, 2025

(54) COATING INSTALLATION AND ASSOCIATED OPERATING METHOD HAVING A SIMULATION OF THE AMOUNT OF COATING AGENT REQUIRED

(71) Applicant: Dürr Systems AG, Bietigheim-Bissingen (DE)

(72) Inventors: Anna Weissenberger, Besigheim (DE); Manfred Michelfelder, Steinheim (DE); Alexander Falheier, Ludwigsburg (DE)

(21) Appl. No.: 18/844,063

(22) PCT Filed: Mar. 15, 2023
(86) PCT No.: PCT/EP2023/056674

§ 371 Date: Sep. 5, 2024

(30) Foreign Application Priority Data
Mar. 18, 2022 (DE) 10 2022 106 432.8

(51) Int. Cl. B05B 12/00; B05B 13/02

(52) U.S. Cl. CPC B05B 12/00; B05B 13/0221

(57) ABSTRACT

The disclosure relates to a coating installation for coating components with a coating agent, including a coating station having a robot station, the robot station having a coating robot, a conveyor for feeding the components to be coated into the coating station an information source for providing a component identifier, the component identifier representing the component type of the component and the coating agent type, a paint supply device for supplying the coating agent to be applied with a specific coating agent quantity, a pig source station at the paint supply device, a pig destination station at the robot station in the coating station, a pig line connecting the pig source station to the pig destination station, and a paint supply controller for controlling the coating agent quantity. The disclosure provides that a simulation computer is provided which simulates a coating of the respective component and determines the required coating agent quantity as part of the simulation.

### CROSS-REFERENCE TO RELATED APPLICATIONS

This application is a national stage of, and claims priority to, Patent Cooperation Treaty Application No. PCT/EP2023/056674, filed on Mar. 15, 2023, which application claims priority to German Application No. DE 10 2022 106 432.8, filed on Mar. 18, 2022, which applications are hereby incorporated herein by reference in their entireties.

### FIELD

The disclosure relates to a coating installation for coating components with a coating agent, in particular for painting motor vehicle body components with a paint. Furthermore, the disclosure relates to a corresponding operating method for such a coating installation.

### BACKGROUND

In modern painting systems for painting motor vehicle body components, rotary atomizers guided by painting robots are usually used as application devices. The painting robots are arranged in a painting booth, with the vehicle body components to be painted being conveyed through the painting booth by a conveyor and then painted in the painting booth.

The paint to be applied is supplied by a paint supply device and conveyed through a pig line to the respective robot station in the painting booth. For this purpose, the required paint quantity is first determined, which depends on the component type of the motor vehicle body to be painted and also on the paint type of the paint to be applied. The required paint quantity is then filled into the pig line by the paint supply device at a pig source station and conveyed by a pig package along the pig line to a pig destination station at the respective robot station. There, the paint is then taken from the pig package and used to paint the respective motor vehicle body. The paint remaining in the pig package is then conveyed along the pig line back to the pig source station in a so-called reflow process. There, the so-called reflow paint can then be taken from the pig package again, allowing the paint to be recycled.

The problem with this type of painting system is determining the required paint quantity, which is filled into the pig package and conveyed through the pig line to the robot station. It has already been mentioned above that the required paint quantity depends on the component type and the type of paint. However, due to the large number of component types used and the equally large number of paint types used, it is hardly possible to maintain the required paint quantity in an allocation table for all combinations of component types and paint types. A great deal of maintenance work is therefore required during the coating process to keep these allocation tables up to date, for example if a new coating type or a new component type has to be entered.

It can therefore happen in painting operation that the paint quantity filled into the pig package does not exactly match the paint quantity actually required. Such fluctuations in paint quantity filled into the pig package compared to the required paint quantity actually also lead to corresponding fluctuations in the speed of movement of the pig package during the reflow process, since the resistance to movement of the pig package in the pig line depends on the amount of paint filled in. For this reason, a certain residual quantity of paint, which is as constant as possible, should be returned to the pig package during a reflow process in order to be able to maintain a defined pig speed as precisely as possible during the reflow movement. The fluctuations in the amount of paint introduced into the pig package compared to the required paint quantity actually therefore lead to corresponding undesirable fluctuations in the pig speed during the reflow process. However, such fluctuations in pig speed during reflow are undesirable for various reasons. For example, in extreme cases, too high a pig speed leads to damage to the pigs, while too low a pig speed leads to a loss of cycle time, i.e., the reflow process is too slow.

Furthermore, with regard to the technical background of the disclosure, reference should also be made to EP 1 837 726 A1, EP 1 270 083 A1, US 2006/0086407 A1, EP 1 380 350 A1, DE 101 20 272 A1 and DE 101 36 328 A1.

### BRIEF DESCRIPTION OF THE DRAWINGS

FIG. 1 shows a schematic representation of part of a coating installation according to the disclosure with a pig source station, a pig line and a pig destination station.

FIG. 2 shows a schematic representation of a painting system according to the disclosure for painting motor vehicle body components.

FIG. 3 shows a flow chart explaining the operating process according to the disclosure.

### DETAILED DESCRIPTION

The disclosure comprises the general technical discovery of determining the coating agent quantity required for coating a component as a function of the respective coating agent type and the respective component type within the framework of a simulation, as will be explained in more detail below.

First of all, the coating installation according to the disclosure comprises, in accordance with the known coating installation described at the beginning, at least one coating station (e.g. painting booth) with a robot station in which a coating robot is arranged in order to coat the components with the coating agent.

In a preferred embodiment of the disclosure, the coating station is a coating booth which has largely closed booth walls except for the inlet and/or outlet. However, with regard to the coating station, the disclosure is not limited to a largely closed coating booth, but can also be implemented, for example, with coating stations that are only functionally closed, but not spatially closed.

Furthermore, it should be mentioned that the disclosure is not limited to motor vehicle body components with regard to the components to be coated. Rather, the concept according to the disclosure is also suitable for coating other types of components.

Furthermore, it should also be mentioned that the disclosure is not limited to paint with respect to the coating agent to be applied. For example, the coating agent can also be an adhesive, an insulating material or a sealant, to name just a few examples.

In the preferred embodiment of the disclosure, the coating robot carries a rotary atomizer as the application device. However, the disclosure is also not limited to rotary atomizers with respect to the application device used. For example, air atomizers or so-called print heads, which are known from the prior art, can also be used as application devices.

In addition, the coating installation according to the disclosure comprises, in accordance with the known coating installation described at the beginning, a conveyor for conveying the components to be coated into the coating station and out of the coating station again. Conveyors of this type are known per se from conventional painting systems for painting motor vehicle body components and therefore need not be described in detail.

Furthermore, the coating installation according to the disclosure comprises, in accordance with the known coating installation described at the beginning, an information source which provides a component identifier which is assigned to the component conveyed into the coating station, the component identifier in each case reflecting the component type of the component conveyed into the coating station by the conveyor and the coating agent type of the coating agent to be applied to the respective component.

In the preferred embodiment of the disclosure, this information source is a reading point arranged upstream of the coating station with respect to the conveyor, in particular at the inlet of the coating station, as is known per se from conventional painting systems for painting motor vehicle body components. This reading point can then read out the component identifier attached to the component or to a component carrier (“skid”), this read-out process preferably being wireless. For example, this readout process can be carried out by means of RFID (radio-frequency identification), by means of a barcode, by means of a light barrier matrix or by means of an inductive sensor solution, to name just a few examples.

Alternatively, however, it is also possible that the source of information for providing the component identifier assigned to the conveyed component is a production control system. For example, the production control system of a paint shop knows the component type of the motor vehicle body component that is fed in each time and also the paint type of the paint to be applied. In this case, no real reading point is required, since the production control system provides a virtual reading point.

In addition, the coating installation according to the disclosure, in accordance with the known coating installation described at the beginning, comprises a paint supply device for providing the coating agent to be applied with a specific coating agent quantity which is required for coating the respective component according to the respective component type and the respective coating agent type. In practice, this paint supply device is usually arranged in a so-called paint mixing room, which is spatially remote from the painting booth.

Furthermore, the coating installation according to the disclosure also comprises a pig source station at the paint supply device and a pig destination station at the respective robot station in the coating station, the pig source station being connected to the pig destination station by a pig line in order to convey the coating agent quantity required for coating the component at the robot station from the paint supply device through the pig line to the robot station.

The paint supply device is controlled by a paint supply controller, which specifies the required quantity of coating agent, which is then filled into the pig line at the pig source station.

The disclosure is distinguished from the coating installation described above by the fact that a simulation computer is provided which simulates a coating process for the respective component. In this simulation, the simulation computer takes into account the component identifier provided by the information source with the component type and the coating agent type. The simulation computer then calculates the coating agent quantity required for coating, taking into account the component type and the coating agent type, and makes the value of the required coating agent quantity determined during the simulation available to the paint supply controller. The paint supply controller then controls the paint supply device in such a way that exactly the previously determined required coating agent quantity is filled into the pig line. It should be mentioned here that, in addition to the required coating agent quantity, a reflow quantity can also be filled into the pig package, whereby the reflow quantity ensures that the pig package is not moved back dry during a reflow process.

In practice, it can happen that the communication between the simulation computer and the paint supply controller does not work, so that the required coating agent quantity determined by the simulation computer during the simulation cannot be transferred to the paint supply controller. In such a case, it makes sense for the paint supply controller to define a standard quantity for the required coating agent quantity, so that the pig source station then fills the pig line with the standard quantity.

Alternatively, it is possible for the paint supply controller to have a paint quantity memory in which the standard quantity required in each case is stored for different component types and different coating agent types. In the event of a faulty reception of the required coating agent quantity from the simulation computer, the paint supply controller can then read out the standard quantity from the paint quantity memory according to the component type and the coating agent type, so that the pig source station then fills the pig line with the read-out standard quantity. In the event of faulty communication between the simulation computer and the paint supply controller, the coating installation according to the disclosure can therefore operate in a similar way to the well-known coating agent system described at the beginning, in which the allocation table with the assignment between component type and coating agent type on the one hand and the required coating agent quantity on the other must be maintained in a time-consuming manner.

Furthermore, within the scope of the disclosure, it is possible for the simulation computer to store a data record for each of the components for later evaluation, which contains the following data:
Component type of the component to be coated,
coating agent type of the coating agent to be applied, and
the required coating agent quantity for coating the component, the required coating agent quantity being determined by the simulation computer.

It has already been mentioned above that the required coating agent quantity is conveyed from the pig source station at the paint supply device to the pig destination station at the robot station. For this purpose, the required coating agent quantity is filled into a pig package in the pig line, the pig package comprising two pigs that enclose the required coating agent quantity between them. The pig source station then conveys the pig package filled with the required coating agent quantity along the pig line to the pig destination station, where the required coating agent quantity can be taken from the pig pack.

After the end of the coating of a component, a certain amount of coating agent usually remains in the pig package, which is available for a so-called reflow process. Thus, after a component has been coated, the pig package is conveyed back from the pig destination station to the pig source station with a certain amount of coating agent in it. This backward movement of the pig package should not occur empty, i.e. without any coating agent filling the pig package, since the friction of the pig package in the pig line also depends on the amount of coating agent in the pig package. In addition, the backward movement of the pig package during the reflow process should also not take place with too large a coating agent filling of the pig package. During the reflow process, the pig package should therefore be filled with a precisely defined amount of coating agent if possible, since the amount of coating agent also influences the speed at which the pig package moves back to the pig source station. A too high movement speed of the pig package during the reflow process can lead to a damage of the pigs. On the other hand, if the pig package moves too slowly during the reflow process, this costs cycle time, i.e. the entire process is slowed down.

The calculation of the required coating agent quantity according to the disclosure now makes it possible for the coating agent quantity remaining in the pig package during the reflow process to be almost constant, which also leads to a correspondingly constant movement speed of the pig package during the reflow process. The reflow velocity of the pig package when returning from the pig destination station to the pig source station can therefore be largely independent of the coating agent type and the component type, with type-dependent deviations being limited to a maximum of 30%, 90%, 10% or even 5%. The same applies to the coating agent quantity returned during a reflow process, which can also be largely constant, with type-dependent deviations limited to at most 30%, 90%, 10% or even 5%.

Movement of the pig package between the pig source station and the pig destination station may be accomplished in a conventional manner by introducing compressed air into the pig line in each case to push the pig package toward the pig source station and the pig destination station, respectively.

Furthermore, it should be mentioned that the robot station may have a station controller that controls the operation of the robot station. The aforementioned simulator computer according to the disclosure can then optionally be integrated into the station controller or into the paint supply controller.

In addition to the coating installation according to the disclosure described above, the disclosure also comprises a corresponding operating method for such a coating installation. The individual process steps of the operating method according to the disclosure are already apparent from the above description of the coating installation according to the disclosure, so that a separate description of the individual process steps can be dispensed with.

Other advantageous further embodiments of the disclosure are indicated in the dependent claims or are explained in more detail below together with the description of the preferred embodiment example of the disclosure with reference to the figures.

In the following, the example of a paint supply system according to the disclosure is described, whereby the paint supply system is used in a painting system for painting motor vehicle body components to supply a rotary atomizer (not shown) with the paint to be applied.

It should be mentioned here that the paint supply system shown is partly identical to the paint supply described in the earlier patent application DE 10 2021 131 136.5, so that supplementary reference is made to this earlier patent application.

Thus, the paint supply comprises a pig source station 1 which is supplied with paint via a plurality of paint connections QFa-QFd.

The pig source station 1 is connected via a pig line 2 to a pig destination station 3, which forwards the paint to be applied via a connection ZF to the rotary atomizer (not shown).

A lubricant valve 4 is arranged in the pig line 2, which will be described in detail later. At this point, it should only be briefly mentioned that the lubricant valve 4 is intended to introduce lubricant into the pig line 2 in order to reduce friction in the pig line 2.

Furthermore, the pig line 2 contains a displaceable pig package consisting of two pigs, namely a pushout pig 5 and a reflow pig 6. In the pig package, a paint column 7 can be clamped between the pushout pig 5 and the reflow pig 6, which is transported from the pig source station 1 to the pig destination station 3 during a pushout process and in the opposite direction from the pig destination station 3 to the pig source station 1 during a reflow process.

In a pushout process, the pig package is moved from the pig source station 1 to the pig destination station 3 by introducing a pushing medium (e.g. compressed air) into the pig line 2 via a connection QMS at the pig source station 1, the pushing medium then transporting the pig package with the pushout pig 5 and the reflow pig 6 along the pig line 2 to the pig destination station 3.

In a reflow process, on the other hand, the pig package with the pushout pig 5 and the reflow pig 6 is transported along the pig line 2 in the reverse direction, i.e. from the pig destination station 3 to the pig source station 1. For this purpose, a pushing medium (e.g. compressed air) is fed into the pig destination station 3 via a connection ZMS. The pushing medium then presses on the reflow pig 6 and transports the complete pig package with the paint column 7 clamped in between along the pig line 2 to the pig source station 1. The paint column 7 returned to the pig source station 1 can then be returned to the paint connections QFa-QFd to enable reuse.

During the reflow process, the pig package with the pushout pig 5 and the reflow pig 6 and the paint column 7 clamped between them moves in the otherwise dry pig line 2, i.e. the pig line 2 is empty between the pushout pig 5 and the pig source station 1. This results in increased friction between the pushout pig 5 and the walls of the pig line 2, which has a negative effect on the service life of the pushout pig 5 and limits the maximum possible speed of movement of the pig package during the reflow process to prevent damage to the pushout pig 5 or the reflow pig 6. The disclosure therefore provides that during a reflow process, a lubricant is fed into the pig line 2 between the pushout pig 5 and the pig source station 1. The lubricant then forms a lubricant column 8 in the pig line 2, which is located upstream of the pushout pig 5 with respect to the direction of movement of the pushout pig 5 during the reflow process. This reduces the friction of the pushout pig 5 during the reflow process in the otherwise empty pig line 2, which enables a greater movement speed of the pig package during the reflow process.

The lubricant is introduced into the pig line 2 through the aforementioned lubricant valve 4, which is located in the pig line 2. When introducing the lubricant into the pig line 2, however, it must be prevented that the lubricant is fed into the paint column 7, which is clamped in the pig package between the pushout pig 5 and the reflow pig 6. This would in fact lead to contamination of the paint in the paint column 7, which would prevent reuse of the paint.

The paint supply system according to the disclosure therefore has a sensor 9 which is arranged on the pig line 2 near the pig destination station 3 and detects the filling state of the pig line 2. Thus, during the reflow process, an air column 10 is located in the pig line 2 in front of the pig package with the clamped paint column 7 in the direction of movement, whereby the sensor 9 can detect whether the air column 10 or the paint column 7 is located at the measuring point in the pig line 2. The sensor 9 is interrogated by a control unit 11, which then controls the lubricant valve 4 accordingly. This means that lubricant is only fed into the pig line 2 via the lubricant valve 4 if the sensor 9 has detected that the air column 10 is located at the measuring point in the pig line 2. If, on the other hand, the sensor 9 detects that the paint column 7 is located in the pig line 2 at the measuring point, the control unit 11 blocks the supply of the lubricant into the pig line 2.

Important here is the position of the lubricant valve 4, which should be located as close as possible to the pig destination station 3, so that the pushout pig 5 is lubricated as far as possible during its entire backward movement from the pig destination station 3 to the pig source station 1 as part of the reflow process. The distance between the lubrication valve 4 and the pig destination station 3 along the pig line can therefore be, for example, less than 10 cm.

Furthermore, the position of the sensor 9 along the pig line 2 is important. Thus, the sensor 9 should be located with its measuring point as close as possible to the lubricant supply point of the lubricant valve 4. This is important so that the sensor 9 then detects the filling state of the pig line 2 at the lubricant supply point of the lubricant valve 4.

Furthermore, it should be mentioned that the control unit 11 also controls numerous valves in the pig source station 1 and numerous valves in the pig destination station 3 to control the operation of the paint supply. At this point, it is only necessary to mention that the pig source station 1 has the following connections:
QFa: Paint connection of the pig source station for paint supply a
QFb: Pig source station paint connection for paint supply b
QFc: Paint connection of the pig source station for paint supply c
QFd: Pig source station paint connection for paint supply d
QHD: Pig source station connection for high pressure supply
QMS: Pig source station connection for feeding sliding medium
QND: Connection of the pig source station for low pressure supply
QRFad: Pig source station recirculation for purging process
QRFbc: Pig source station recirculation for purging process
QV: Pig source station connection for diluent supply
RF: Recirculation
QZYe: Pig source station connection for cylinder retraction
QZYa: Connection of the pig source station for extending the cylinder
QRFD: Connection of pig source station for throttle return
QMPI: Connection of pig source station push-out initiator
QMRI: Pig source station connection reflow initiator

Furthermore, it should be mentioned that the pig destination station 3 still comprises the following connections:
ZF: Connection of the pig destination station for dispensing paint to the applicator
ZRF: Connection of the pig destination station for delivery of paint in recirculation
ZHD: Connection of the pig destination station for feeding high pressure
ZND: pig destination station connection for low pressure supply
ZMS: Connection of the pig destination station for feeding pig sliding medium
ZRFD: Connection of the pig destination station for pig return throttle.
ZMRI: Pig destination station pig reflow initiator

It should also be mentioned that the pig source station 1 is at an electrical ground potential during operation. The pig destination station 3, on the other hand, can optionally be placed at ground potential or at high voltage potential to enable electrostatic coating agent charging. When the pig destination station 3 is charged to high voltage potential, the pig line 2 is completely drained and cleaned to form the largest possible electrical resistivity to allow potential separation between the pig source station 1 on the one hand and the pig destination station 3 on the other.

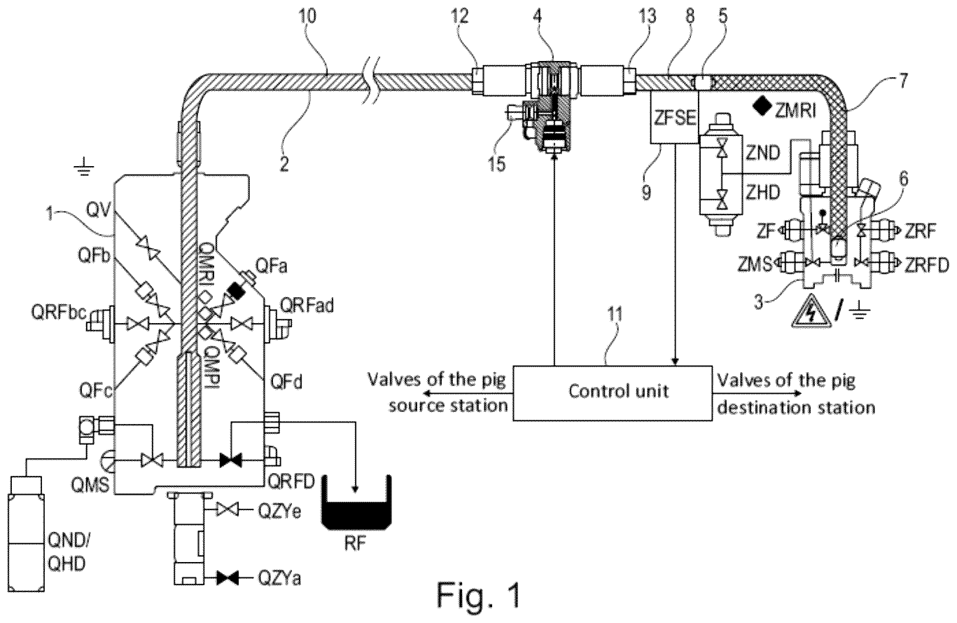

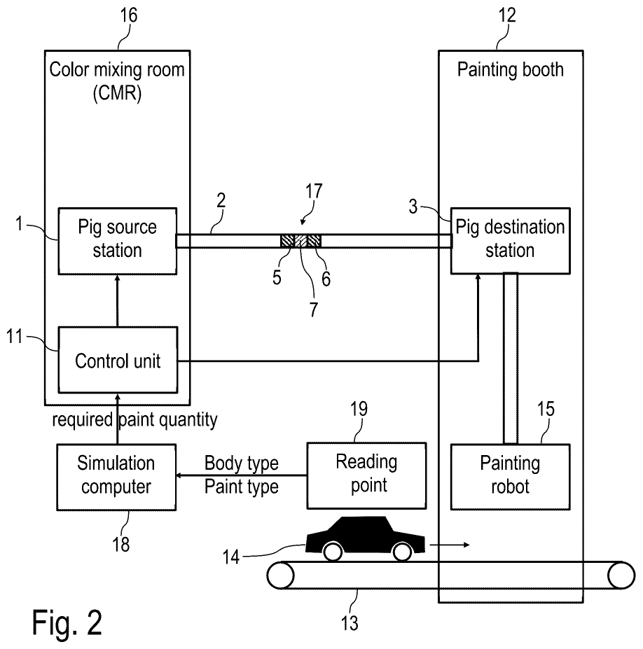

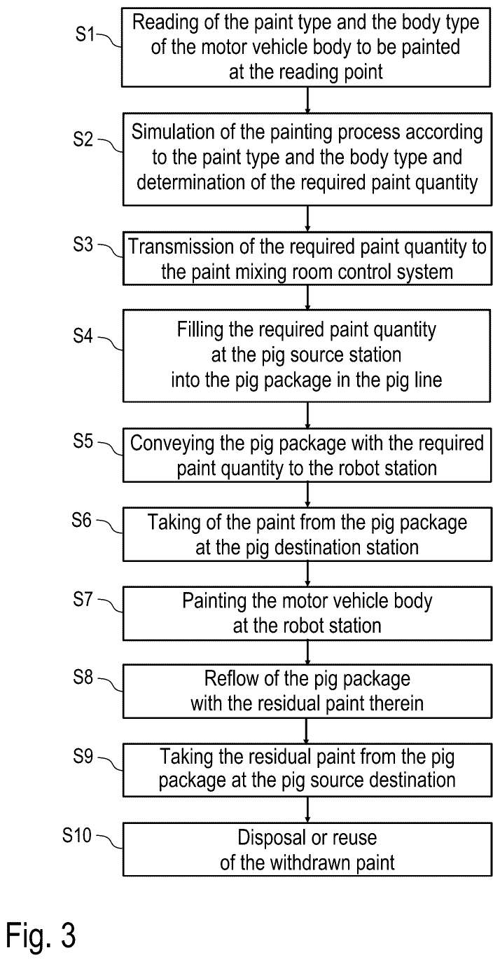

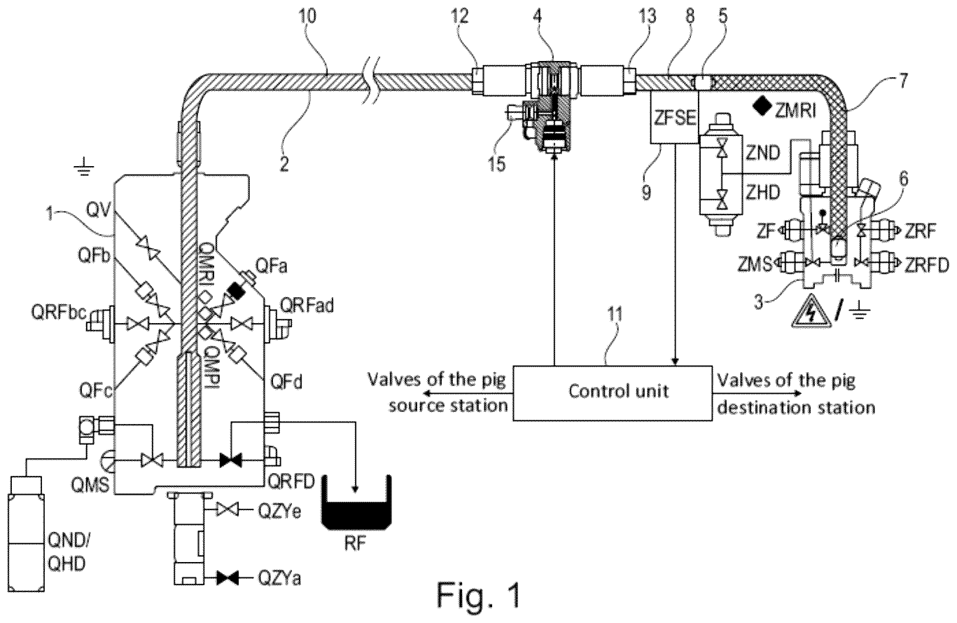

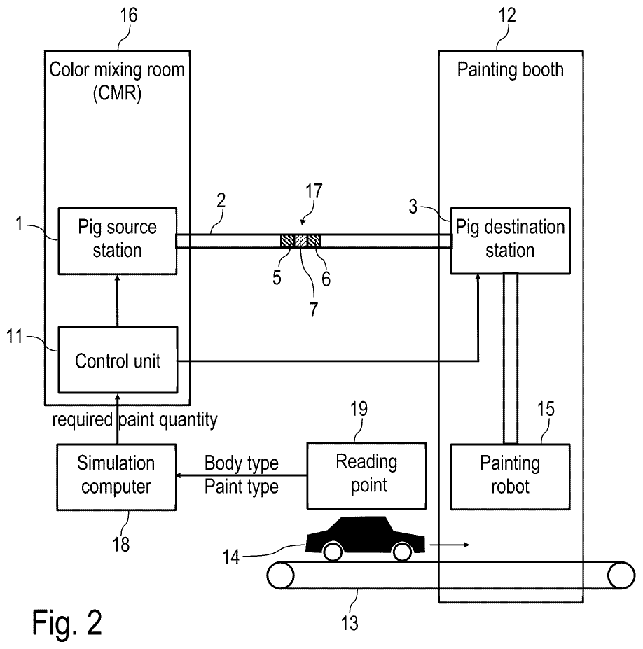

In the following, FIG. 2 will now be described, which shows the integration of the pigging system described above and shown in FIG. 1 in a paint shop.

The painting system comprises a painting booth 12, with a conveyor 13 conveying the motor vehicle bodies 14 to be painted in the direction of the arrow through the painting booth 12, as indicated only schematically by an arrow in the drawing.

The pig destination station 3 is arranged in the painting booth 12 and is used to supply paint to a painting robot 15.

In addition, the drawing shows a paint mixing room 16 with the pig source station 1 arranged therein.

Furthermore, the drawing shows that the control unit 11 already shown in FIG. 1 controls the pig source station 1 so that the pig source station 1 fills the required paint quantity into a pig package 17 consisting of the pushout pig 5 and the reflow pig 6.

The required paint quantity is determined by a simulation computer 18 as part of a simulation of the painting process. The simulation computer 18 takes into account the type of motor vehicle body 14 to be painted and also the type of paint to be applied, since both variables (paint type and body type) influence the required paint quantity.

For this purpose, the painting system has a reading point 19, which is arranged at the inlet of the painting booth 12 and reads out a component identifier on the incoming motor vehicle body 14. This reading process can be carried out, for example, by means of an RFID transponder on the motor vehicle body 14 or by reading a bar code on the motor vehicle body 14. The read component identifier contains, on the one hand, the component type of the motor vehicle body 14 and, on the other hand, the paint type of the paint to be applied. This information is transmitted from the reading point 19 to the simulation computer 18, which then simulates the actual painting process and determines required paint quantity. This value is then transferred to the control unit 11 for the paint mixing room 16.

The control unit 11 then controls the pig source station 1 so that the required paint quantity is filled into the pig line 2.

The control unit 11 then also controls the pig source station 1 so that the pig package 17 with the paint quantity filled into it is conveyed to the pig destination station 3. For this purpose, compressed air is introduced into the pig line 2 at the pig source station 1 downstream of the pig package 17, with the compressed air then pushing the pig package 17 to the pig destination station 3.

After a painting process of a component, a certain amount of paint then remains in the pig package 17. This remaining amount of paint is then conveyed back to the pig source station 1 with the pig package 17 as part of a reflow process. For this purpose, compressed air is introduced into the pig line 2 at the pig destination station 3. The compressed air then guides the pig package 17 back to the pig source station 1. There, the amount of paint remaining in the pig package 17 can then be taken from the pig package 17 and optionally disposed of or reused.

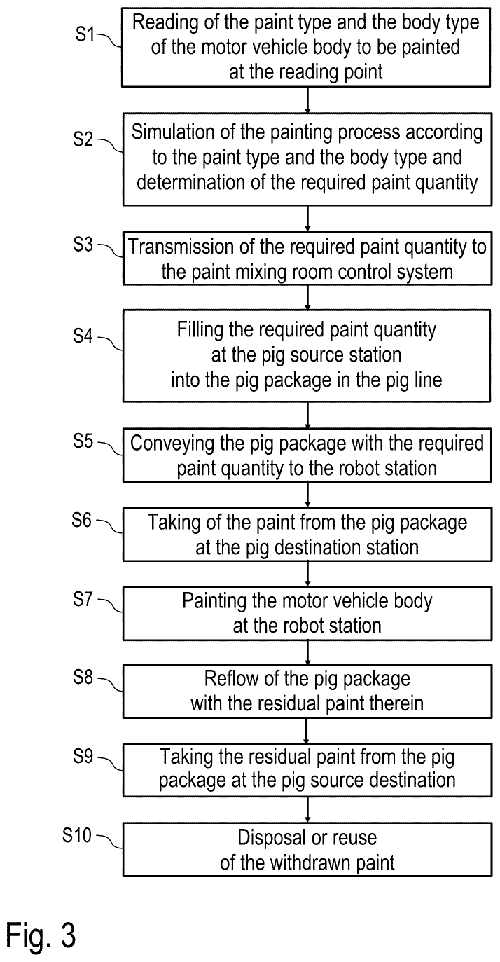

In the following, the flow chart according to FIG. 3 will now be described, which explains the operating method according to the disclosure.

In a first step S1, the paint type and the type of motor vehicle body 14 to be painted are first read out at the reading point 19.

Subsequently, in step S2, a simulation of the painting process is carried out according to the paint type and the motor vehicle body type, whereby the required paint quantity is determined as part of the simulation.

The required paint quantity is then transferred to the control unit 11 of the paint mixing room 16 in a step S3.

In a step S4, the control unit 11 then controls the pig source station 1 so that the required paint quantity is filled into the pig package 17 in the pig line 2.

In the next step S5, the filled pig package 17 with the required paint quantity contained therein is then conveyed along the pig line 2 to the robot station with the pig destination station 3.

The next step S6 then provides for the paint to be taken from the pig package 17 at the pig destination station 3.

In the next step S7, the motor vehicle body 14 can then be painted with the taken paint at the robot station.

After completion of the painting process, a so-called re-flow of the pig package 17 with the remaining paint from the pig destination station 3 back to the pig source station 1 then takes place in a step S8.

In the pig source station 1, the paint remaining in the pig package 17 can then be taken from the pig package 17, which is done in a step S9.

In the next step S10, the paint taken during the reflow process can then either be disposed of or reused.

1.-17. (canceled)

18. A coating installation for coating components with a coating agent, having
a) a coating station with at least one robot station arranged in the coating station, the robot station comprising a coating robot for coating the components with the coating agent,
b) a conveyor for feeding the components to be coated into the coating station,
c) an information source for providing a component identifier which is assigned to the component fed into the coating station, the component identifier in each case representing the component type of the component fed into the coating station by the conveyor and the coating agent type of the coating agent to be applied to the respective component,
d) a paint supply device for providing the coating agent to be applied with a specific coating agent quantity required for coating the respective component according to the respective component type and the respective coating agent type,
e) a pig source station at the paint supply device,
f) a pig destination station at the robot station in the coating station,
g) a pig line connecting the pig source station to the pig destination station for conveying the coating agent quantity required for coating the component at the robot station from the paint supply device through the pig line to the robot station, and
h) a paint supply controller for controlling the coating agent quantity which is filled into the pig line from the paint supply device at the pig source station and conveyed through the pig line to the pig destination station, wherein
i) a simulation computer is provided which simulates a coating of the respective component,
j) the simulation computer receives from the information source the component identifier with the component type and the coating agent type for the respective component which is fed into the coating station by the conveyor,
k) the simulation computer calculates from the component type and the coating agent type, by simulating the coating, the required coating agent quantity which is required at the robot station for coating the respective component, and
l) the simulation computer transmits the required coating agent quantity to the paint supply controller, so that the paint supply controller fills the required coating agent quantity into the pig line with the pig source station.

19. The coating installation according to claim 18, wherein the paint supply control determines a standard quantity for the required coating agent quantity in the event of a disturbed reception of the required coating agent quantity from the simulation computer, so that the pig source station fills the pig line with the standard quantity.

20. The coating installation according to claim 18, wherein
a) the paint supply controller has a paint quantity memory in which the standard quantity required in each case is stored for different component types and different coating agent types,
b) the paint supply controller reads out the standard quantity from the paint quantity memory in the event of disturbed reception of the required coating agent quantity from the simulation computer, so that the pig source station fills the pig line with the standard quantity.

21. The coating installation according to claim 18, wherein the simulation computer stores a respective data record for each of the components for subsequent evaluation, which data record contains the following data:
a) the component type of the component to be coated,
b) the coating agent type of the coating agent to be applied, and
c) the coating agent quantity required to coat the component at the robot station, as determined by the simulation computer.

22. The coating installation according to claim 18, wherein
a) the pig source station fills the required coating agent quantity into a pig package in the pig line, the pig package comprising two pigs which enclose the required coating agent quantity between them,
b) the pig source station conveys the pig package filled with the required coating agent quantity along the pig line to the pig destination station, and
c) that the pig destination station takes the required coating agent quantity from the pig package.

23. The coating installation according to claim 22, wherein
a) after the end of a component coating process, the pig destination station conveys the pig package with the coating agent remaining therein back along the pig line to the pig source station at a specific return speed, and
b) the pig source station takes the coating agent from the returned pig package for reuse or for disposal.

24. The coating installation according to claim 23, wherein the quantity of the coating agent returned is essentially constant irrespective of the type of the coating agent and also irrespective of the type of the component, namely with type-dependent deviations of at most 30%.

25. The coating installation according to claim 23, wherein the return speed of the pig package during the return of the coating agent from the pig destination station to the pig source station is substantially constant independently of the coating agent type and also independently of the component type, namely with type-dependent deviations of at most 30%.

26. The coating installation according to claim 23, wherein the pig source station conveys the pig package to the pig destination station by the pig source station introducing compressed air into the pig line, the compressed air pressing the pig package to the pig destination station.

27. The coating installation according to claim 23, wherein the pig destination station conveys the pig package to the pig source station by the pig destination station introducing compressed air into the pig line, wherein the compressed air presses the pig package to the pig source station.

28. The coating installation according to claim 18, wherein
a) the robot station has a station controller which controls the operation of the robot station, and
b) the simulation computer is integrated into the station controller or into the paint supply controller.

29. The coating installation according to claim 18, wherein the coating booth has only one inlet for conveying the components into the coating booth through the inlet and also for conveying them out of the coating booth again through the inlet.

31. The coating installation according to claim 18, wherein the coating booth has an inlet and an additional outlet, the components to be coated being conveyed into the coating booth through the inlet and being conveyed out of the coating booth through the outlet.

32. The coating installation according to claim 18, wherein
a) the coating agent is a paint.
b) the components to be coated are motor vehicle body components, and
c) the coating robot guides a rotary atomizer as application device for painting.

33. The coating installation according to claim 18, wherein the information source for providing the component identifier assigned to the conveyed-in component is a reading point which is arranged upstream of the coating station with respect to the conveyor, the reading point reading out the component identifier on the component or on a component carrier.

34. The coating installation according to claim 33, wherein the reading point is adapted to read out the component identifier wirelessly.

35. The coating installation according to claim 18, wherein the information source for providing the component identifier assigned to the conveyed component is a production controller.
